(19) United States
(12) Patent Application Publication
(10) Pub. No.: US 2026/0146157 A1
(43) Pub. Date: May 28, 2026

(54) RESIN COMPOSITION AND ARTICLE MADE THEREFROM

(71) Applicant: Elite Material Co., Ltd., Taoyuan City (TW)

(72) Inventor: Chen-Yu HSIEH, Taoyuan City (TW)

(21) Appl. No.: 19/002,191

(22) Filed: Dec. 26, 2024

(30) Foreign Application Priority Data
Nov. 28, 2024 (TW) 113145921

(51) Int. Cl. C08L 71/12; B32B 15/08; B32B 15/20; C08F 212/36; C08F 222/10; C08G 61/10; C08G 73/10

(52) U.S. Cl. CPC C08L 71/126; B32B 15/08; B32B 15/20; C08F 212/36; C08F 222/102; C08G 61/10; C08G 73/10; B32B 2311/12; B32B 2457/08; C08L 2205/03

(57) ABSTRACT

A resin composition includes a vinyl group-containing resin, which includes a vinyl group-containing polyphenylene ether resin, a maleimide resin, a vinyl group-containing polyolefin resin, a vinyl group-containing aromatic fluorene compound or a combination thereof, and a prepolymer, which is prepared from a mixture subjected to a prepolymerization reaction, the mixture including a vinyltoluene-divinylbenzene copolymer, a vinyl group-containing aromatic fluorene compound and a benzocyclobutene-modified polybutadiene diacrylate. The resin composition may be useful for making different articles, including a resin-coated copper, a laminate or a printed circuit board.

### CROSS-REFERENCE TO RELATED APPLICATION

This application claims the priority benefits of Taiwan Patent Application No. 113145921, filed on Nov. 28, 2024. The entirety of the above-mentioned patent application is hereby incorporated by reference herein and made a part of this specification.

### BACKGROUND

### 1. Field of the Disclosure

The present disclosure relates to a resin composition and more particularly to a resin composition useful for preparing a resin-coated copper, a laminate or a printed circuit board.

### 2. Description of Related Art

In recent years, due to the development of electronic signal transmission toward 5G and the trend of miniaturization and high performance of electronic equipment, communication devices and personal computers, circuit boards for these applications were also developed toward multi-layer configuration, high density trace interconnection, and high speed signal transmission, thereby presenting higher challenges to the overall performance of circuit laminates such as copper-clad laminates.

Accordingly, there is a need to provide a novel material meeting the property requirements of circuit boards used nowadays.

### SUMMARY

To overcome the problems of prior arts, particularly one or more property demands facing conventional materials, it is a primary object of the present disclosure to provide a resin composition and an article made from the resin composition, which may achieve improvements in at least one or more desirable properties including water absorption ratio in a pressure cooking test, dissipation factor, copper foil peeling strength, X-axis coefficient of thermal expansion, and bending ability.

To achieve the above-mentioned objects, the present disclosure provides a resin composition, comprising:
a vinyl group-containing resin, which comprises a vinyl group-containing polyphenylene ether resin, a maleimide resin, a vinyl group-containing polyolefin resin, a vinyl group-containing aromatic fluorene compound or a combination thereof; and
a prepolymer prepared from a mixture subjected to a prepolymerization reaction, the mixture comprising a vinyltoluene-divinylbenzene copolymer, a vinyl group-containing aromatic fluorene compound and a benzocyclobutene-modified polybutadiene diacrylate.

For example, in one embodiment, relative to 100 parts by weight of the vinyl group-containing polyphenylene ether resin, the amount of the prepolymer may be 10 parts by weight to 60 parts by weight.

For example, in one embodiment, the mixture comprises 100 parts by weight of the vinyltoluene-divinylbenzene copolymer, 5 parts by weight to 20 parts by weight of the vinyl group-containing aromatic fluorene compound and 15 parts by weight to 30 parts by weight of the benzocyclobutene-modified polybutadiene diacrylate.

For example, in one embodiment, the vinyl group-containing polyphenylene ether resin comprises a vinylbenzyl group-containing biphenyl polyphenylene ether resin, a methacrylate group-containing polyphenylene ether resin or a combination thereof.

For example, in one embodiment, the maleimide resin comprises 4,4′-diphenylmethane bismaleimide, polyphenylmethane maleimide, bisphenol A diphenyl ether bismaleimide, 3,3′-dimethyl-5,5′-diethyl-4,4′-diphenylmethane bismaleimide, 3,3′-dimethyl-5,5′-dipropyl-4,4′-diphenylmethane bismaleimide, m-phenylene bismaleimide, 4-methyl-1,3-phenylene bismaleimide, 1,6-bismaleimide-(2,2,4-trimethyl)hexane, N-2,3-dimethylphenyl maleimide, N-2,6-dimethylphenyl maleimide, N-phenylmaleimide, vinyl benzyl maleimide, maleimide containing biphenyl structure, maleimide containing indane structure, maleimide containing C₁₀ to C₅₀ aliphatic long chain structure or a combination thereof.

For example, in one embodiment, the vinyl group-containing polyolefin resin comprises polybutadiene, polyisoprene, butadiene-styrene copolymer, polydicyclopentadiene, styrene-isoprene copolymer, styrene-butadiene-divinylbenzene terpolymer, styrene-butadiene-maleic anhydride terpolymer, vinyl-polybutadiene-urethane oligomer, maleic anhydride-butadiene copolymer, polymethylstyrene, styrene-maleic anhydride copolymer, maleic anhydride-modified polybutadiene-styrene copolymer or a combination thereof.

For example, in one embodiment, the vinyl group-containing aromatic fluorene compound comprises a compound of Formula (1):

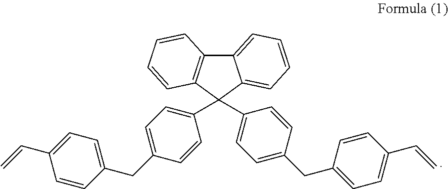 [SMILES: C=Cc1ccc(Cc2ccc(C3(c4ccc(Cc5ccc(C=C)cc5)cc4)c4ccccc4-c4ccccc43)cc2)cc1]

For example, in one embodiment, the resin composition further comprises a vinyl group-substituted 9,10-dihydro-9-oxa-10-phosphaphenanthrene-10-oxide.

For example, in one embodiment, the resin composition further comprises inorganic filler, flame retardant, curing accelerator, polymerization inhibitor, solvent, silane coupling agent, coloring agent, toughening agent, or a combination thereof.

In another aspect, the present disclosure also provides an article made from the resin composition described above, which comprises a resin-coated copper, a laminate or a printed circuit board.

For example, in one embodiment, the article described above has at least one, more or all of the following properties:
a water absorption ratio in a pressure cooking test (PCT water absorption ratio) as measured by reference to IPC-TM-650 2.6.16.1 of less than or equal to 0.28%; a dissipation factor as measured by reference to JIS C2565 at 10 GHz of less than or equal to 0.00186;
a copper foil peeling strength as measured by reference to IPC-TM-650 2.4.8 of greater than or equal to 3.04 lb/in;
an X-axis coefficient of thermal expansion as measured by reference to IPC-TM-650 2.4.24.5 of less than or equal to 25.23 ppm/° C.; and
no cracks appearing in a semi-cured resin layer after a bending ability test.

### DESCRIPTION OF THE EMBODIMENTS

To enable those skilled in the art to further appreciate the features and effects of the present disclosure, words and terms contained in the specification and appended claims are described and defined. Unless otherwise defined, all technical and scientific terms used herein have the same meaning as commonly understood by those of ordinary skill in the art to which this disclosure pertains. In the case of conflict, the present document and definitions contained herein will control.

While some theories or mechanisms may be proposed herein, the present disclosure is not bound by any theories or mechanisms described regardless of whether they are right or wrong, as long as the embodiments can be implemented according to the present disclosure.

As used herein, “a,” “an” or any similar expression is employed to describe components and features of the present disclosure. This is done merely for convenience and to give a general sense of the scope of the present disclosure. Accordingly, this description should be read to include one or at least one and the singular also includes the plural unless it is obvious to mean otherwise.

As used herein, the term “comprises,” “comprising,” “includes,” “including,” “has,” “having” or any other variant thereof is construed as an open-ended transitional phrase intended to cover a non-exclusive inclusion. For example, a composition comprising a list of elements or an article made therefrom encompasses any one or any type of the listed elements and is not necessarily limited to only those elements listed herein, but may also include other elements not expressly listed or inherent to such composition or article. Further, unless expressly stated to the contrary, the term “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). In addition, whenever open-ended transitional phrases are used, such as “encompasses,” “encompassing,” “comprises,” “comprising,” “includes,” “including,” “has,” “having” or any other variant thereof, it is understood that close-ended transitional phrases such as “consisting of,” “composed by” and “remainder being” and partially open-ended transitional phrases such as “consisting essentially of,” “primarily consisting of,” “mainly consisting of,” “primarily containing,” “composed essentially of,” “essentially having,” etc. are also disclosed and included.

As used herein, “or a combination thereof” means “or any combination thereof”, which encompasses any combination of two or more of the listed elements, and “any” means “any one”, vice versa. For example, “a composition or an article made therefrom includes A, B, C or a combination thereof” is construed to encompass the following situations: Ais true (or present), and B and C are false (or not present); B is true (or present), and A and C are false (or not present); C is true (or present), and A and B are false (or not present); A and B are true (or present), and C is false (or not present); A and C are true (or present), and B is false (or not present); B and C are true (or present), and A is false (or not present); and A and B and C are all true (or present), and it is also contemplated that the composition or an article thereof contains or does not contain elements other than A, B and C not expressly listed but inherent to such composition or article.

As used herein, the term “and” or any other variant thereof is used to connect parallel sentence components, and there is no distinction between the front and rear components. The meaning of the parallel sentence components does not change in the grammatical sense after the position is exchanged.

In this disclosure, features and conditions such as values, numbers, contents, amounts or concentrations are presented as a numerical range or a percentage range merely for convenience and brevity. Therefore, a numerical range or a percentage range should be interpreted as encompassing and specifically disclosing all possible subranges and individual numerals or values therein, including integers and fractions, particularly all integers therein. For example, a range of “1.0 to 8.0” or “between 1.0 and 8.0” should be understood as explicitly disclosing all subranges such as 1.0 to 8.0, 1.0 to 7.0, 2.0 to 8.0, 2.0 to 6.0, 3.0 to 6.0, 4.0 to 8.0, 3.0 to 8.0 and so on and encompassing the endpoint values, particularly subranges defined by integers, as well as disclosing all individual values in the range such as 1.0, 2.0, 3.0, 4.0, 5.0, 6.0, 7.0 and 8.0. Unless otherwise defined, the aforesaid interpretation rule should be applied throughout the present disclosure regardless of broadness of the scope.

Whenever amount, concentration or other numeral or parameter is expressed as a range, a preferred range or a series of upper and lower limits, it is understood that all ranges defined by any pair of the upper limit or preferred value and the lower limit or preferred value are specifically disclosed, regardless whether these ranges are explicitly described or not. In addition, unless otherwise defined, whenever a range is mentioned, the range should be interpreted as inclusive of the endpoints and every integers and fractions in the range.

Given the intended purposes and advantages of this disclosure are achieved, numerals or figures have the precision of their significant digits. For example, 40. should be understood as covering a range of 39.50 to 40.49.

As used herein, a Markush group or a list of items is used to describe examples or embodiments of the present disclosure. A skilled artisan will appreciate that all subgroups of members or items and individual members or items of the Markush group or list can also be used to describe the present disclosure. For example, when X is described as being “selected from a group consisting of X₁, X₂ and X₃,” it is intended to disclose the situations of X is X₁ and X is X₁ and/or X₂ and/or X₃. In addition, when a Markush group or a list of items is used to describe examples or embodiments of the present disclosure, a skilled artisan will understand that any subgroup or any combination of the members or items in the Markush group or list may also be used to describe the present disclosure. Therefore, for example, when X is described as being “selected from a group consisting of X₁, X₂ and X₃” and Y is described as being “selected from a group consisting of Y₁, Y₂ and Y₃,” the disclosure encompasses any combination of X is X₁ and/or X₂ and/or X₃ and Y is Y₁ and/or Y₂ and/or Y₃.

Unless otherwise specified, according to the present disclosure, a compound refers to a chemical substance formed by two or more elements bonded with chemical bonds and may comprise a small molecule compound and a polymer compound, but not limited thereto. Any compound disclosed herein is interpreted to not only include a single chemical substance but also include a class of chemical substances having the same kind of components or having the same property.

Unless otherwise specified, according to the present disclosure, a polymer refers to the product formed by monomer(s) via polymerization and usually comprises multiple aggregates of polymers respectively formed by multiple repeated simple structure units by covalent bonds; the monomer refers to the compound forming the polymer. A polymer may comprise a homopolymer, a copolymer, a prepolymer, etc., but not limited thereto. A homopolymer refers to the polymer formed by the polymerization of one monomer. A copolymer refers to the polymer formed by the polymerization of two or more types of monomers. Copolymers comprise: random copolymers, such as a structure of -AABABBBAAABBA-; alternating copolymers, such as a structure of -ABABABAB-; graft copolymers, such as a structure of -AA(A-BBBB)AA(A-BBBB)AAA-; and block copolymers, such as a structure of -AAAAA-BBBBBB-AAAAA-. For example, in the present disclosure, a butadiene-styrene copolymer is interpreted as comprising a butadiene-styrene random copolymer, a butadiene-styrene alternating copolymer, a butadiene-styrene graft copolymer or a butadiene-styrene block copolymer. For another example, a vinyltoluene-divinylbenzene copolymer is interpreted as comprising a vinyltoluene-divinylbenzene random copolymer, a vinyltoluene-divinylbenzene alternating copolymer, a vinyltoluene-divinylbenzene graft copolymer or a vinyltoluene-divinylbenzene block copolymer. A prepolymer refers to a polymer having a lower molecular weight between the molecular weight of monomer and the molecular weight of final polymer, and a prepolymer contains a reactive functional group capable of participating further polymerization to obtain the final polymer product which has been fully crosslinked or cured. The term “polymer” includes but is not limited to an oligomer. An oligomer refers to a polymer with 2 to 20, typically 2 to 5, repeating units.

To those of ordinary skill in the art to which this disclosure pertains, a resin composition containing a vinyl group-containing resin and three compounds (e.g., A, B and C), a total of four components, is different from a resin composition containing the vinyl group-containing resin and a prepolymer formed by the three compounds (e.g., A, B and C), a total of two components, as they are completely different from each other in the aspects of preparation method, physical or chemical properties of the resin composition and properties of an article or product made therefrom. For example, the former involves mixing A, B, C and the vinyl group-containing resin to form the resin composition; in contrast, the latter involves first subjecting a mixture comprising A, B and C to a prepolymerization reaction at proper conditions to form a prepolymer and then mixing the prepolymer with the vinyl group-containing resin to form the resin composition. For example, to those of ordinary skill in the art to which this disclosure pertains, the two resin compositions have completely different compositions; in addition, because the prepolymer formed by A, B and C functions completely different from A, B and C individually or collectively in the resin composition, the two resin compositions should be construed as completely different chemical substances and have completely different chemical statuses. For example, to those of ordinary skill in the art to which this disclosure pertains, because the two resin compositions are completely different chemical substances, articles made therefrom will not have the same properties. For example, to a resin composition containing a vinyl group-containing resin and a prepolymer formed by A, B and C, since A, B and C have been partially reacted or converted during the prepolymerization reaction to form the prepolymer, during the process of heating to semi-cure the resin composition at a high temperature condition, a partial crosslinking reaction occurs between the prepolymer and the vinyl group-containing resin but not between A, B and C individually and the vinyl group-containing resin. As such, articles made from the two resin compositions will be completely different and have completely different properties.

Unless otherwise specified, the term “resin” of the present disclosure is a widely used common name of a synthetic polymer and is construed as comprising monomer and its combination, polymer and its combination or a combination of monomer and its polymer, but not limited thereto.

Unless otherwise specified, according to the present disclosure, a modification comprises a product derived from a resin with its reactive functional group modified, a product derived from a prepolymerization reaction of a resin and other resins, a product derived from a crosslinking reaction of a resin and other resins, a product derived from copolymerizing a resin and other resins, etc.

Unless otherwise specified, according to the present disclosure, the term “vinyl group” is construed as comprising a vinyl group and a vinylene group, and the term “(meth)acryloyl group” is construed as comprising an acryloyl group and a methacryloyl group.

Unless otherwise specified, the alkyl group, the alkenyl group and the monomer described herein are construed to encompass various isomers thereof. For example, a propyl group is construed to encompass n-propyl and iso-propyl.

Unless otherwise specified, as used herein, part(s) by weight represents weight part(s) in any weight unit in the resin composition, such as but not limited to kilogram, gram, pound and so on. For example, 100 parts by weight of a vinyl group-containing resin may represent 100 kilograms of the vinyl group-containing resin or 100 pounds of the vinyl group-containing resin. Unless otherwise specified, in the present disclosure, wt % represents weight (or mass) percentage.

It should be understood that all features disclosed herein may be combined in any way to constitute the technical solution of the present disclosure, as long as there is no conflict present in the combination of these features.

Examples and embodiments are described in detail below. It will be understood that these examples and embodiments are exemplary only and are not intended to limit the scope and use of the present disclosure. Unless otherwise specified, processes, reagents and conditions described in the examples are those known in the art.

As described above, the present disclosure provides a resin composition, comprising the following components:
a vinyl group-containing resin, which comprises a vinyl group-containing polyphenylene ether resin, a maleimide resin, a vinyl group-containing polyolefin resin, a vinyl group-containing aromatic fluorene compound or a combination thereof; and
a prepolymer prepared from a mixture subjected to a prepolymerization reaction, the mixture comprising a vinyltoluene-divinylbenzene copolymer, a vinyl group-containing aromatic fluorene compound and a benzocyclobutene-modified polybutadiene diacrylate.

For example, the vinyl group-containing polyphenylene ether resin may include but is not limited to a polyphenylene ether resin containing a vinyl group, an allyl group, a vinylbenzyl group or a methacrylate group. For example, in one embodiment, the vinyl group-containing polyphenylene ether resin comprises a vinylbenzyl group-containing biphenyl polyphenylene ether resin, a methacrylate group-containing polyphenylene ether resin (i.e., methacryloyl group-containing polyphenylene ether resin), an allyl group-containing polyphenylene ether resin, a vinylbenzyl group-modified bisphenol A polyphenylene ether resin, a chain-extended vinyl group-containing polyphenylene ether resin or a combination thereof. For example, the vinyl group-containing polyphenylene ether resin may be a vinylbenzyl group-terminated polyphenylene ether resin with a number average molecular weight of about 1200 (such as OPE-2st 1200, available from Mitsubishi Gas Chemical Co., Inc.), a vinylbenzyl group-terminated polyphenylene ether resin with a number average molecular weight of about 2200 (such as OPE-2st 2200, available from Mitsubishi Gas Chemical Co., Inc.), a methacrylate group-containing polyphenylene ether resin with a number average molecular weight of about 1900 to 2300 (such as SA9000, available from Sabic), a vinylbenzyl group-modified bisphenol A polyphenylene ether resin with a number average molecular weight of about 2400 to 2800, a chain-extended vinyl group-containing polyphenylene ether resin with a number average molecular weight of about 2200 to 3000, or a combination thereof. The chain-extended vinyl group-containing polyphenylene ether resin may include various polyphenylene ether resins disclosed in the US Patent Application Publication No. 2016/0185904 A1, all of which are incorporated herein by reference in their entirety.

For example, the maleimide resin may comprise 4,4′-diphenylmethane bismaleimide, polyphenylmethane maleimide (a.k.a. oligomer of phenylmethane maleimide), bisphenol A diphenyl ether bismaleimide, 3,3′-dimethyl-5,5′-diethyl-4,4′-diphenylmethane bismaleimide, 3,3′-dimethyl-5,5′-dipropyl-4,4′-diphenyl methane bismaleimide, m-phenylene bismaleimide, 4-methyl-1,3-phenylene bismaleimide, 1,6-bismaleimide-(2,2,4-trimethyl)hexane, N-2,3-xylylmaleimide, N-2,6-xylylmaleimide, N-phenylmaleimide, vinyl benzyl maleimide (VBM), maleimide containing biphenyl structure, maleimide containing indane structure, maleimide resin containing C₁₀ to C₅₀ aliphatic long chain structure, prepolymer of diallyl compound and maleimide resin, prepolymer of multi-functional amine (i.e., an amine including two or more amino groups) and maleimide resin, prepolymer of acid phenol compound and maleimide resin, or a combination thereof. These components should be construed as including their modifications.

For example, examples of the maleimide resin include but are not limited to products such as BMI-1000, BMI-1000H, BMI-1100, BMI-1100H, BMI-2000, BMI-2300, BMI-3000, BMI-3000H, BMI-4000, BMI-5000, BMI-5100, BMI-TMH, BMI-7000, and BMI-7000H available from Daiwakasei Industry, products such as BMI-70 and BMI-80 available from K.I Chemical Industry Co., Ltd., or products such as MIR-3000 and MIR-5000 available from Nippon Kayaku. For example, examples of the maleimide resin containing aliphatic long chain structure (such as containing C₁₀ to C₅₀ aliphatic long chain structure) include, but are not limited to, products such as BMI-689, BMI-1400, BMI-1500, BMI-1700, BMI-2500, BMI-3000, BMI-5000 and BMI-6000 available from Designer Molecules Inc. For example, examples of the maleimide containing indane structure include, but are not limited to, products such as NE-X-9470 available from D.I.C. Corporation.

The vinyl group-containing polyolefin resin suitable for the present disclosure is not particularly limited and may include any one or more vinyl group-containing olefin polymers useful for making a resin-coated copper, a laminate, or a printed circuit board, such as any one or more commercial products, products prepared by the Applicant or a combination thereof.

For example, the vinyl group-containing polyolefin resin described herein includes but is not limited to a diene polymer, a monoene polymer or a combination thereof, generally having a number average molecular weight of between 1,000 to 150,000.

In some embodiments, examples of the vinyl group-containing polyolefin resin comprise, but not limited to, polybutadiene, polyisoprene, butadiene-styrene copolymer, polydicyclopentadiene, styrene-isoprene copolymer, styrene-butadiene-divinylbenzene terpolymer, styrene-butadiene-maleic anhydride terpolymer, vinyl-polybutadiene-urethane oligomer, maleic anhydride-butadiene copolymer, polymethylstyrene, styrene-maleic anhydride copolymer, maleic anhydride-modified polybutadiene-styrene copolymer or a combination thereof. These components should be construed as including their modifications. According to the present disclosure, the vinyl group-containing polyolefin is interpreted as comprising a random copolymer, an alternating copolymer, a graft copolymer, a block copolymer or a combination thereof.

For example, according to the present disclosure, the vinyl group-containing aromatic fluorene compound is not particularly limited and may include any one or more vinyl group-containing aromatic fluorene compounds useful for making a resin-coated copper, a laminate, or a printed circuit board, such as any one or more commercial products, products prepared by the Applicant or a combination thereof.

For example, the vinyl group-containing aromatic fluorene compound may comprise any fluorene compound having a reactive vinyl group and containing one or more aromatic rings (such as benzene rings), examples including but not limited to the compound of Formula (1):

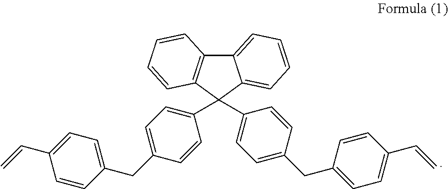 [SMILES: C=Cc1ccc(Cc2ccc(C3(c4ccc(Cc5ccc(C=C)cc5)cc4)c4ccccc4-c4ccccc43)cc2)cc1]

In the resin composition disclosed herein, the amount or ratio of the vinyl group-containing resin and the prepolymer is not particularly limited. For example, in one embodiment, the resin composition of the present disclosure may comprise 100 parts by weight of the vinyl group-containing resin and 10 parts by weight to 60 parts by weight of the prepolymer. For example, relative to 100 parts by weight of the vinyl group-containing resin, the amount of the prepolymer may be 10 parts by weight, 20 parts by weight, 30 parts by weight, 40 parts by weight, 50 parts by weight or 60 parts by weight, but not limited thereto.

According to the present disclosure, the prepolymer is prepared from a mixture subjected to a prepolymerization reaction, wherein the mixture at least comprises a vinyltoluene-divinylbenzene copolymer, a vinyl group-containing aromatic fluorene compound (as defined above) and a benzocyclobutene-modified polybutadiene diacrylate.

For example, in one embodiment, the vinyltoluene-divinylbenzene copolymer may have the structure below:

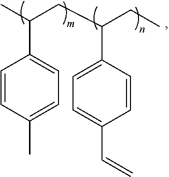

its weight average molecular weight is about 50,000, m:n is about 0.8:0.2, and the order of each repeating unit may be arbitrary.

For example, in one embodiment, the vinyl group-containing aromatic fluorene compound may be the compound of Formula (1).

For example, in one embodiment, the benzocyclobutene-modified polybutadiene diacrylate may have the structure below:

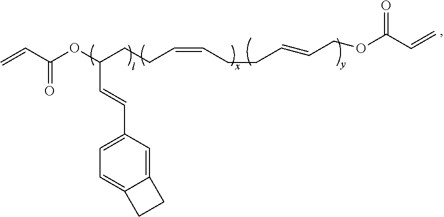

its weight average molecular weight is about 5,000 to 5,500, l:x:y is about 0.65:0.225:0.125, and the order of each repeating unit may be arbitrary.

According to the present disclosure, for example, the progress of the prepolymerization reaction may be confirmed and controlled as needed by determining the molecular weight or the level of viscosity. Prepolymerization reaction disclosed herein may be initiated by the use of solvent and heating or by a thermal melting reaction, but not limited thereto. For example, prepolymerization by the use of solvent and heating refers to dissolving the raw material in a solvent, optionally adding a catalyst or a polymerization inhibitor, followed by heating after all components are dissolved in the solvent, so as to initiate the prepolymerization reaction. Prepolymerization by a thermal melting reaction refers to heating to melt the raw material and at the same time initiate the prepolymerization reaction. The product after prepolymerization (i.e., the prepolymer) has a molecular weight of greater than that of the compound monomer or mixture monomer prior to prepolymerization.

For example, the prepolymerization reaction may be performed in the presence of a catalyst. The type of the catalyst is not particularly limited and may comprise, for example, azobisisobutyronitrile (AIBN), dibenzoyl peroxide, 2,2′-azobis(2,4,4-trimethylpentane) or a combination thereof, but not limited thereto.

For example, the prepolymerization reaction may be performed in the presence of a solvent. The type of the solvent is not particularly limited and may comprise, for example, toluene, but not limited thereto.

For example, the conditions of the prepolymerization reaction are not particularly limited. For example, the mixture can be prepolymerized at a temperature of 60° C. to 130° C. for 2 to 6 hours to obtain the prepolymer. In one embodiment, the reaction temperature of the prepolymerization reaction is, such as but not limited thereto, 60° C., 70° C., 80° C., 90° C., 100° C., 110° C., 120° C. or 130° C. and a specific point value between the above values. For the purpose of brevity and conciseness, not all specific point values are described and listed exhaustively herein. In one embodiment, the prepolymerization reaction has a reaction time of 2 to 6 hours, such as but not limited to 2 hours, 3 hours, 4 hours, 5 hours or 6 hours, as well as any specific point value between the aforesaid values. For the purpose of brevity and conciseness, not all specific point values are described and listed exhaustively herein.

For example, the prepolymerization reaction has a conversion rate of greater than 0% and less than 100% (exclusive of 0% and 100%), such as but not limited to a conversion rate of between 10% and 90% (inclusive of 10% and 90%). Specifically, the prepolymerization reaction having a conversion rate of 0% represents no reaction of the monomer and therefore fails to form the prepolymer of the present disclosure. Similarly, the prepolymerization reaction having a conversion rate of 100% represents a complete reaction of the monomer and therefore also fails to form the prepolymer of the present disclosure.

When the aforementioned mixture is subjected to the prepolymerization reaction, the amount of each component (monomer) in the mixture is not particularly limited. For example, in one embodiment, the mixture comprises 100 parts by weight of the vinyltoluene-divinylbenzene copolymer, 5 parts by weight to 20 parts by weight of the vinyl group-containing aromatic fluorene compound (as defined above, such as the compound of Formula (1)) and 15 parts by weight to 30 parts by weight of the benzocyclobutene-modified polybutadiene diacrylate.

In addition to the aforementioned vinyl group-containing resin and prepolymer, in one embodiment, for example, the resin composition of the present disclosure may also optionally comprise other components, such as one or more additives. For example, in one embodiment, the additive may comprise various components used in the art for formulating materials of a printed circuit board. For example, the additive suitable for the present disclosure is not particularly limited and may be any one or more additives useful for making a resin-coated copper, a laminate or a printed circuit board, such as any one or more commercial products, products prepared by the Applicant or a combination thereof. For example, in one embodiment, the additive comprises but is not limited to a vinyl group-substituted 9,10-dihydro-9-oxa-10-phosphaphenanthrene-10-oxide (DOPO), and the amount thereof may be 10 parts by weight to 30 parts by weight relative to 100 parts by weight of the vinyl group-containing resin, but not limited thereto.

In addition to the aforesaid components, the resin composition may also optionally comprise inorganic filler, flame retardant, curing accelerator, polymerization inhibitor, solvent, silane coupling agent, coloring agent, toughening agent or a combination thereof, but not limited thereto. Unless otherwise specified, relative to 100 parts by weight of the vinyl group-containing resin, the content of any aforesaid component may be 0.001 to 400 parts by weight, such as 0.001, 0.01, 0.1, 1, 5, 10, 20, 30, 40, 50, 60, 70, 80, 90, 100, 150, 200, 250, 300, 350, 370 or 400 parts by weight, such as 30 parts by weight to 150 parts by weight or 160 parts by weight to 370 parts by weight.

For example, the inorganic filler may be any one or more inorganic fillers used for preparing a resin-coated copper, a laminate or a printed circuit board; examples of the inorganic filler include but are not limited to silica (fused, non-fused, porous or hollow type), aluminum oxide, aluminum hydroxide, magnesium oxide, magnesium hydroxide, calcium carbonate, aluminum nitride, boron nitride, aluminum silicon carbide, silicon carbide, titanium dioxide, zinc oxide, zirconium oxide, mica, boehmite (AlOOH), calcined talc, talc, silicon nitride and calcined kaolin. Moreover, the inorganic filler can be spherical, fibrous, plate-like, particulate, flake-like or whisker-like in shape and can be optionally pretreated by a silane coupling agent. Unless otherwise specified, the amount of the inorganic filler described above is not particularly limited and may for example range from 30 parts by weight to 300 parts by weight of the inorganic filler relative to 100 parts by weight of the vinyl group-containing resin, preferably ranging from 110 parts by weight to 230 parts by weight of the inorganic filler relative to 100 parts by weight of the vinyl group-containing resin.

For example, the flame retardant used herein may be any one or more flame retardants useful for preparing a resin-coated copper, a laminate or a printed circuit board, examples including but not limited to a phosphorus-containing flame retardant, preferably comprising: ammonium polyphosphate, hydroquinone bis-(diphenyl phosphate), bisphenol A bis-(diphenylphosphate), tri(2-carboxyethyl) phosphine (TCEP), phosphoric acid tris(chloroisopropyl) ester, trimethyl phosphate (TMP), dimethyl methyl phosphonate (DMMP), resorcinol bis(dixylenyl phosphate) (RDXP, such as commercially available PX-200, PX-201, and PX-202), phosphazene (such as commercially available SPB-100, SPH-100, and SPV-100), melamine polyphosphate, DOPO (9,10-dihydro-9-oxa-10-phosphaphenanthrene-10-oxide) and its derivatives or resins, DPPO (diphenylphosphine oxide) and its derivatives or resins, melamine cyanurate, tri-hydroxy ethyl isocyanurate, aluminium phosphinate (e.g., commercially available OP-930 and OP-935), or a combination thereof.

For example, the flame retardant may be a DPPO compound (e.g., di-DPPO compound, such as commercially available PQ-60), a DOPO compound (e.g., di-DOPO compound), a DOPO resin (e.g., DOPO-HQ, DOPO-NQ, DOPO-PN, and DOPO-BPN) and a DOPO-containing epoxy resin, wherein DOPO-PN is a DOPO phenol novolac compound, and DOPO-BPN may be a DOPO-containing bisphenol novolac compound, such as DOPO-BPAN (DOPO-bisphenol A novolac), DOPO-BPFN (DOPO-bisphenol F novolac) or DOPO-BPSN (DOPO-bisphenol S novolac).

The curing accelerator (including curing initiator) may comprise a catalyst, such as a Lewis base or a Lewis acid. The Lewis base may comprise any one or more of imidazole, boron trifluoride-amine complex, ethyltriphenyl phosphonium chloride, 2-methylimidazole (2MI), 2-phenyl-1H-imidazole (2PZ), 2-ethyl-4-methylimidazole (2E4MI), triphenylphosphine (TPP) and 4-dimethylaminopyridine (DMAP). The Lewis acid may comprise metal salt compounds, such as those of manganese, iron, cobalt, nickel, copper and zinc, such as zinc octanoate or cobalt octanoate.

The curing accelerator may also encompass curing initiator such as a peroxide capable of producing free radicals, and examples of the curing initiator may comprise but not limited to: 2,2′-azobis(2,4,4-trimethylpentane), benzoyl peroxide, dicumyl peroxide, 2,5-dimethyl-2,5-di(t-butylperoxy)hexane, 2,5-dimethyl-2,5-di(t-butyl peroxy)-3-hexyne, di-t-butyl peroxide, di(t-butylperoxyisopropyl)benzene, di(t-butylperoxy)phthalate, di(t-butylperoxy)isophthalate, t-butyl peroxybenzoate, 2,2-di(t-butylperoxy)butane, 2,2-di(t-butylperoxy)octane, 2,5-dimethyl-2,5-di(benzoyl peroxy)hexane, lauroyl peroxide, t-hexyl peroxypivalate, dibutylperoxyisopropylbenzene, bis(4-t-butylcyclohexyl) peroxydicarbonate, or a combination thereof. For example, relative to 100 parts by weight of the vinyl group-containing resin, the amount of curing accelerator used in the present disclosure may range from 0.01 to 5 parts by weight, preferably 0.3 to 1 part by weight.

In one embodiment, for example, the polymerization inhibitor used herein is not particularly limited and may be any polymerization inhibitor known in the field to which this disclosure pertains, including but not limited to various commercially available polymerization inhibitor products. For example, the polymerization inhibitor may comprise, but not limited to, 1,1-diphenyl-2-picrylhydrazyl radical, methyl acrylonitrile, dithioester, nitroxide-mediated radical, triphenylmethyl radical, metal ion radical, sulfur radical, hydroquinone, 4-methoxyphenol, p-benzoquinone, phenothiazine, 0-phenylnaphthylamine, 4-t-butylcatechol, methylene blue, 4,4′-butylidenebis(6-t-butyl-3-methylphenol), 2,2′-methylenebis(4-ethyl-6-t-butylphenol) or a combination thereof. For example, the nitroxide-mediated radical may comprise, but not limited to, nitroxide radicals derived from cyclic hydroxylamines, such as 2,2,6,6-substituted piperidine 1-oxyl free radical, 2,2,5,5-substituted pyrrolidine 1-oxyl free radical or the like. Preferred substitutes include alkyl groups with 4 or fewer carbon atoms, such as methyl group or ethyl group. Examples of the compound containing a nitroxide radical include such as 2,2,6,6-tetramethylpiperidine 1-oxyl free radical, 2,2,6,6-tetraethylpiperidine 1-oxyl free radical, 2,2,6,6-tetramethyl-4-oxo-piperidine 1-oxyl free radical, 2,2,5,5-tetramethylpyrrolidine 1-oxyl free radical, 1,1,3,3-tetramethyl-2-isoindoline oxygen radical, N,N-di-tert-butylamine oxygen free radical and so on. Nitroxide radicals may also be replaced by using stable radicals such as galvinoxyl radicals. The polymerization inhibitor suitable for the resin composition of the present disclosure may include products derived from the polymerization inhibitor with its hydrogen atom or group substituted by other atom or group. Examples include products derived from a polymerization inhibitor with its hydrogen atom substituted by an amino group, a hydroxyl group, a carbonyl group or the like. For example, in one embodiment, relative to 100 parts by weight of the vinyl group-containing resin, the resin composition of the present disclosure may comprise 0.001 part by weight to 2 parts by weight of polymerization inhibitor.

The purpose of adding solvent is to change the solid content of the resin composition and to adjust the viscosity of the resin composition. For example, the solvent may comprise, but not limited to, methanol, ethanol, ethylene glycol monomethyl ether, acetone, butanone (methyl ethyl ketone), methyl isobutyl ketone, cyclohexanone, toluene, xylene, methoxyethyl acetate, ethoxyethyl acetate, propoxyethyl acetate, ethyl acetate, dimethylformamide, dimethylacetamide, propylene glycol methyl ether, or a mixture thereof. The amount of solvent is not particularly limited and may be adjusted according to the solid content required for the resin composition. For example, relative to 100 parts by weight of the vinyl group-containing resin, the amount of solvent used herein may be 100 parts by weight to 400 parts by weight, such as 150 parts by weight, 200 parts by weight, 250 parts by weight, 300 parts by weight or 350 parts by weight, but not limited thereto.

The silane coupling agent may include various silanes (such as but not limited to siloxane) or a combination thereof and may be further categorized according to the functional groups into amino silane, epoxide silane, vinyl silane, acrylate silane, methacrylate silane, hydroxyl silane, isocyanate silane, methacryloxy silane and acryloxy silane.

The coloring agent suitable for the present disclosure may comprise, but not limited to, dye or pigment.

The purpose of adding toughening agent is to improve the toughness of the resin composition. The toughening agent may comprise, but not limited to, rubber resin, carboxyl-terminated butadiene acrylonitrile rubber (CTBN rubber), core-shell rubber, or a combination thereof.

In addition to the aforesaid resin composition, the present disclosure also provides an article made from the resin composition, such as those suitable for use as components in various electronic products, including but not limited to a resin-coated copper, a laminate or a printed circuit board.

For example, in one embodiment, the resin composition of the present disclosure may be used to make a resin-coated copper. For example, the resin composition from one embodiment of the present disclosure may be coated on a copper foil, followed by heating and baking to semi-cure the resin composition, so as to form a resin-coated copper. The suitable baking temperature may be 95° C. to 150° C., preferably 110° C. to 130° C., and the suitable baking time may be 1 minute to 10 minutes, preferably 4 minutes to 6 minutes. The resin-coated copper may comprise a copper foil and a semi-cured resin layer adhered on one side of the copper foil, wherein the semi-cured resin layer is obtained by semi-curing the resin composition.

For example, the resin-coated copper may further comprise a protective film layer. That is, the resin-coated copper may comprise a copper foil, a semi-cured resin layer adhered on one side of the copper foil and a protective film layer adhered on the other side of the semi-cured resin layer.

For example, the type of copper foil of the resin-coated copper is not limited and may be various copper foils commonly used in the art, such as but not limited to high temperature elongation (HTE) copper foil, reverse treated foil (RTF), reverse treated foil 2 (RTF2), very low profile (VLP) copper foil, hyper very low profile (HVLP) copper foil, hyper very low profile 2 (HVLP2) copper foil, carrier-attached copper foil, etc. The thickness of the copper foil is not limited and may be a common thickness of copper foil used in the art, such as but not limited to Toz (ounce), Hoz, 1 oz, 2 oz, etc.

For example, the resin composition described herein may be made into a laminate, which comprises at least two metal foils and at least one insulation layer disposed between the metal foils, wherein the insulation layer is made by curing the resin composition at high temperature and high pressure to the C-stage. For example, the semi-cured resin layers on each one side of the two resin-coated coppers were butt-joined and laminated so that each copper foil layer of the two resin-coated coppers faces outwards, followed by lamination and curing at high temperature and high pressure, so as to obtain the laminate. For example, the semi-cured resin layer on one side of one aforesaid resin-coated copper was stacked on another copper foil so that the two copper foil layers were on the outer side of the semi-cured resin layer, followed by lamination and curing at high temperature and high pressure, so as to obtain the laminate. A suitable curing temperature may be for example between 180° C. and 240° C., preferably between 210° C. and 230° C.; a curing time may be 90 to 150 minutes, preferably 110 to 130 minutes; and a suitable lamination pressure may be for example between 200 psi and 500 psi, preferably between 250 psi and 350 psi. For example, the insulation layer of the laminate may be obtained by laminating and curing the semi-cured resin layer of at least one resin-coated copper. The laminate may be a copper clad laminate.

In one embodiment, the laminate may be further processed by trace formation processes to obtain a circuit board, such as a printed circuit board.

In one or more embodiments, the articles made from the resin composition disclosed herein may have at least one, preferably at least two, more or all, of the following properties:
a water absorption ratio in a pressure cooking test as measured by reference to IPC-TM-650 2.6.16.1 of less than or equal to 0.28%, such as between 0.21% and 0.28%;
a dissipation factor as measured by reference to JIS C2565 at 10 GHz of less than or equal to 0.00186, such as between 0.00127 and 0.00186;
a copper foil peeling strength as measured by reference to IPC-TM-650 2.4.8 of greater than or equal to 3.04 lb/in, such as between 3.04 lb/in and 3.24 lb/in;
an X-axis coefficient of thermal expansion as measured by reference to IPC-TM-650 2.4.24.5 of less than or equal to 25.23 ppm/° C., such as between 23.33 ppm/° C. and 25.23 ppm/° C.; and no cracks appearing in a semi-cured resin layer after a bending ability test.

Methods for measuring the aforesaid properties will be elaborated in detail below.

Raw materials below were used to prepare the resin compositions of various Examples and Comparative Examples of the present disclosure according to the amount listed in Table 1 to Table 3 and further fabricated to prepare test samples.

Materials and reagents used in Synthesis Examples, Examples and Comparative Examples disclosed herein are listed below:
OPE-2st 2200: vinylbenzyl group-containing biphenyl polyphenylene ether resin, available from Mitsubishi Gas Chemical Co., Inc.
SA9000: methacrylate group-containing polyphenylene ether resin, available from Sabic.
NE-X-9470: maleimide containing indane structure, available from DIC Corporation.
B-1000: polybutadiene, available from Nippon Soda Co., Ltd.
Formula (1): compound of Formula (1), as shown below, available from Kingyorker Enterprise Co., Ltd.

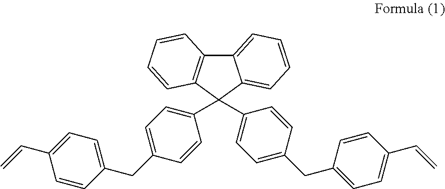 [SMILES: C=Cc1ccc(Cc2ccc(C3(c4ccc(Cc5ccc(C=C)cc5)cc4)c4ccccc4-c4ccccc43)cc2)cc1]

Prepolymer 1 to Prepolymer 8: as described in Synthesis Example 1 to Synthesis Example 8.
H007: vinyltoluene-divinylbenzene copolymer, available from Chin Yee Chemical Co., Ltd.
DFE996: benzocyclobutene-modified polybutadiene diacrylate, available from Sichuan EM Technology Co., Ltd.
Vinyl-DOPO: vinyl group-substituted 9,10-dihydro-9-oxa-10-phosphaphenanthrene-10-oxide, as shown below, available from Shandong Xingshun New Material Co., Ltd.

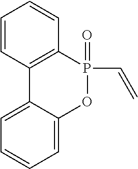 [SMILES: C=CP1(=O)Oc2ccccc2-c2ccccc21]

VR-110: 2,2′-azobis(2,4,4-trimethylpentane), available from Fuji Film Wako Pure Chemical Corporation.
SC2050: silica, available from Admatechs. In the Tables, the amount symbol “R” of inorganic filler represents that the amount of inorganic filler is a multiple of the total amount of all other components excluding inorganic filler, curing accelerator and solvent in the resin composition of each Example or each Comparative Example. In the Tables, “R*100%” represents the amount of inorganic filler is 1 fold of the total amount of the aforesaid all other components. For example, in Example E1, R*100% represents that the amount of inorganic filler is 145 parts by weight (the total amount of all other components excluding inorganic filler, curing accelerator and solvent in E1 is 145 parts by weight, so the amount of inorganic filler is 145 parts by weight times 100%, which is 145 parts by weight).
Toluene: commercially available. The amount of solvent is shown as “PA” in the Tables to indicate a “proper amount” to represent an amount of solvent used to achieve a 60% to 68% total solid content (S/C=60% to 68%) of the resin composition.

### Synthesis Example 1

In a reaction tank, 100 parts by weight of H007, 12 parts by weight of a compound of Formula (1), 22 parts by weight of DFE996, 100 parts by weight of toluene and 0.5 part by weight of azobisisobutyronitrile were added, well mixed and dissolved by heating, followed by reacting at the constant temperature of 70° C. for 4 hours and then cooled to room temperature to obtain Prepolymer 1, which is the prepolymer of the present disclosure.

### Synthesis Example 2

In a reaction tank, 100 parts by weight of H007, 5 parts by weight of a compound of Formula (1), 22 parts by weight of DFE996, 100 parts by weight of toluene and 1.0 part by weight of azobisisobutyronitrile were added, well mixed and dissolved by heating, followed by reacting at the constant temperature of 70° C. for 4 hours and then cooled to room temperature to obtain Prepolymer 2, which is the prepolymer of the present disclosure.

### Synthesis Example 3

In a reaction tank, 100 parts by weight of H007, 20 parts by weight of a compound of Formula (1), 22 parts by weight of DFE996, 100 parts by weight of toluene and 1.5 parts by weight of dibenzoyl peroxide were added, well mixed and dissolved by heating, followed by reacting at the constant temperature of 80° C. for 4 hours and then cooled to room temperature to obtain Prepolymer 3, which is the prepolymer of the present disclosure.

### Synthesis Example 4

In a reaction tank, 100 parts by weight of H007, 12 parts by weight of a compound of Formula (1), 15 parts by weight of DFE996, 100 parts by weight of toluene and 1.0 part by weight of 2,2′-azobis(2,4,4-trimethylpentane) were added, well mixed and dissolved by heating, followed by reacting at the constant temperature of 120° C. for 4 hours and then cooled to room temperature to obtain Prepolymer 4, which is the prepolymer of the present disclosure.

### Synthesis Example 5

In a reaction tank, 100 parts by weight of H007, 12 parts by weight of a compound of Formula (1), 30 parts by weight of DFE996, 100 parts by weight of toluene and 0.5 part by weight of dibenzoyl peroxide were added, well mixed and dissolved by heating, followed by reacting at the constant temperature of 90° C. for 4 hours and then cooled to room temperature to obtain Prepolymer 5, which is the prepolymer of the present disclosure.

### Synthesis Example 6

In a reaction tank, 100 parts by weight of H007, 12 parts by weight of a compound of Formula (1), 100 parts by weight of toluene and 0.5 part by weight of dibenzoyl peroxide were added, well mixed and dissolved by heating, followed by reacting at the constant temperature of 90° C. for 4 hours and then cooled to room temperature to obtain Prepolymer 6.

### Synthesis Example 7

In a reaction tank, 100 parts by weight of H007, 22 parts by weight of DFE996, 100 parts by weight of toluene and 0.5 part by weight of 2,2′-azobis(2,4,4-trimethylpentane) were added, well mixed and dissolved by heating, followed by reacting at the constant temperature of 120° C. for 4 hours and then cooled to room temperature to obtain Prepolymer 7.

### Synthesis Example 8

In a reaction tank, 12 parts by weight of a compound of Formula (1), 22 parts by weight of DFE996, 100 parts by weight of toluene and 0.5 part by weight of azobisisobutyronitrile were added, well mixed and dissolved by heating, followed by reacting at the constant temperature of 70° C. for 4 hours and then cooled to room temperature to obtain Prepolymer 8.

Compositions (in part by weight) and test results of resin compositions of Examples and Comparative Examples are listed below, wherein the part by weight refers to the amount, in part by weight, of each component with a solid content of 100%. For example, Example E1 contains 45 parts by weight of Prepolymer 1, indicating the amount of Prepolymer 1, with a solid content of 100%, is 45 parts by weight.

TABLE 1
Resin compositions of Examples (in part by weight) and test results

| Component | Name | E1 | E2 | E3 | E4 | E5 | E6 | E7 |
|---|---|---|---|---|---|---|---|---|
| vinyl-group | OPE-2st 2200 | 100 | 100 | 100 | 100 | 100 | 100 | 100 |
| containing resin | SA9000 | | | | | | | |
| | NE-X-9470 | | | | | | | |
| | B-1000 | | | | | | | |
| | Formula (1) | | | | | | | |
| prepolymer | Prepolymer 1 | 45 | 10 | 60 | | | | |
| | Prepolymer 2 | | | | 45 | | | |
| | Prepolymer 3 | | | | | 45 | | |
| | Prepolymer 4 | | | | | | 45 | |
| | Prepolymer 5 | | | | | | | 45 |
| | Prepolymer 6 | | | | | | | |
| | Prepolymer 7 | | | | | | | |
| | Prepolymer 8 | | | | | | | |
| monomer | H007 | | | | | | | |
| | Formula (1) | | | | | | | |
| | DFE996 | | | | | | | |
| additive | vinyl-DOPO | | | | | | | |
| curing accelerator | VR-110 | 0.6 | 0.6 | 0.6 | 0.6 | 0.6 | 0.6 | 0.6 |
| inorganic filler | SC2050 | R*100% | R*100% | R*100% | R*100% | R*100% | R*100% | R*100% |
| solvent | toluene | PA | PA | PA | PA | PA | PA | PA |
| Property | Unit | E1 | E2 | E3 | E4 | E5 | E6 | E7 |
| PCT water | % | 0.27 | 0.28 | 0.25 | 0.26 | 0.27 | 0.26 | 0.25 |
| absorption ratio | | | | | | | | |
| dissipation factor | none | 0.00169 | 0.00186 | 0.00163 | 0.00181 | 0.00161 | 0.00153 | 0.00172 |
| copper foil peeling | lb/in | 3.15 | 3.08 | 3.17 | 3.14 | 3.24 | 3.19 | 3.15 |
| strength | | | | | | | | |
| X-CTE | ppm/° C. | 24.45 | 25.23 | 24.65 | 24.56 | 24.25 | 24.81 | 24.19 |
| bending ability | mm | N | N | N | N | N | N | N |

TABLE 2
Resin compositions of Examples (in part by weight) and test results

| Component | Name | E8 | E9 | E10 | E11 | E12 | E13 |
|---|---|---|---|---|---|---|---|
| vinyl-group | OPE-2st 2200 | 50 | | 50 | | 25 | 40 |
| containing resin | SA9000 | 50 | 70 | | 70 | 40 | |
| | NE-X-9470 | | 30 | | | | 50 |
| | B-1000 | | | 15 | | 20 | |
| | Formula (1) | | | 35 | 30 | 15 | 10 |
| prepolymer | Prepolymer 1 | 20 | 45 | 30 | 50 | 10 | 20 |
| | Prepolymer 2 | 25 | | | | | 20 |
| | Prepolymer 3 | | | 5 | | 10 | |
| | Prepolymer 4 | | | 10 | | | 20 |
| | Prepolymer 5 | | | | | 10 | |
| | Prepolymer 6 | | | | | | |
| | Prepolymer 7 | | | | | | |
| | Prepolymer 8 | | | | | | |
| monomer | H007 | | | | | | |
| | Formula (1) | | | | | | |
| | DFE996 | | | | | | |
| additive | vinyl-DOPO | | | | 20 | 10 | 30 |
| curing accelerator | VR-110 | 0.6 | 0.6 | 0.6 | 0.6 | 0.35 | 1.0 |
| inorganic filler | SC2050 | R*100% | R*100% | R*100% | R*100% | R*80% | R*120% |
| solvent | toluene | PA | PA | PA | PA | PA | PA |
| Property | Unit | E8 | E9 | E10 | E11 | E12 | E13 |
| PCT water | % | 0.26 | 0.27 | 0.25 | 0.26 | 0.21 | 0.23 |
| absorption ratio | | | | | | | |
| dissipation factor | none | 0.00161 | 0.00159 | 0.00183 | 0.00169 | 0.00127 | 0.00146 |
| copper foil peeling | lb/in | 3.19 | 3.14 | 3.15 | 3.06 | 3.05 | 3.04 |
| strength | | | | | | | |
| X-CTE | ppm/° C. | 24.51 | 24.39 | 24.44 | 23.47 | 23.37 | 23.33 |
| bending ability | mm | N | N | N | N | N | N |

TABLE 3
Resin compositions of Comparative Examples (in part by weight) and test results

| Component | Name | C1 | C2 | C3 | C4 | C5 |
|---|---|---|---|---|---|---|
| vinyl-group | OPE-2st 2200 | 100 | 100 | 100 | 100 | 50 |
| containing resin | SA9000 | | | | | |
| | NE-X-9470 | | | | | |
| | B-1000 | | | | | 15 |
| | Formula (1) | | | | | 35 |
| prepolymer | Prepolymer 1 | | | | | |
| | Prepolymer 2 | | | | | |
| | Prepolymer 3 | | | | | |
| | Prepolymer 4 | | | | | |
| | Prepolymer 5 | | | | | |
| | Prepolymer 6 | 45 | | | | |
| | Prepolymer 7 | | 45 | | | |
| | Prepolymer 8 | | | 45 | | |
| monomer | H007 | | | | 34 | |
| | Formula (1) | | | | 4 | |
| | DFE996 | | | | 7 | |
| additive | vinyl-DOPO | | | | | |
| curing accelerator | VR-110 | 0.6 | 0.6 | 0.6 | 0.6 | 0.6 |
| inorganic filler | SC2050 | R*100% | R*100% | R*100% | R*100% | R*100% |
| solvent | toluene | PA | PA | PA | PA | PA |
| Property | Unit | C1 | C2 | C3 | C4 | C5 |
| PCT water absorption | % | 0.34 | 0.48 | 0.45 | 0.35 | 0.37 |
| ratio | | | | | | |
| dissipation factor | none | 0.00193 | 0.00392 | 0.00377 | 0.00337 | 0.00311 |
| copper foil peeling | lb/in | 2.98 | 2.57 | 2.89 | 2.67 | 2.42 |
| strength | | | | | | |
| X-CTE | ppm/° C. | 28.42 | 29.31 | 26.07 | 27.87 | 30.87 |
| bending ability | mm | Y | Y | Y | CC | CC |
| | | (1.73 mm) | (1.62 mm) | (1.54 mm) | | |

Samples (specimens) for the properties measured above were prepared as described below and tested and analyzed under specified conditions below.

### 1. First Resin-Coated Copper

Resin composition (all in part by weight) from each Example (E1 to E13) or each Comparative Example (C1 to C5) was separately added to a stirred tank and well-mixed to form a varnish, which was coated on a hyper very low profile (HVLP, with a thickness of 1 ounce) copper foil to uniformly adhere the resin composition thereon, followed by heating and baking at 120° C. for 5 minutes to form a semi-cured resin layer, so as to obtain the first resin-coated copper. The first resin-coated copper has a copper foil layer and a semi-cured resin layer, wherein the semi-cured resin layer has a thickness of 100 m.

### 2. Second Resin-Coated Copper

Resin composition (all in part by weight) from each Example (E1 to E13) or each Comparative Example (C1 to C5) was separately added to a stirred tank and well-mixed to form a varnish, which was coated on a hyper very low profile (HVLP, with a thickness of 1 ounce) copper foil to uniformly adhere the resin composition thereon, followed by heating and baking at 120° C. for 5 minutes to form a semi-cured resin layer, so as to obtain the second resin-coated copper. The second resin-coated copper has a copper foil layer and a semi-cured resin layer, wherein the semi-cured resin layer has a thickness of 150 m.

### 3. First Copper-Containing Laminate (Obtained by Laminating Two First Resin-Coated

Coppers) Two first resin-coated coppers of each Example and each Comparative Example obtained as described above were prepared and stacked, wherein the semi-cured resin layers of two first resin-coated coppers were adjacent to the inner side, and two outer sides were copper foil layers, followed by lamination and curing for 2 hours in a high temperature laminator under a vacuum environment with a lamination pressure of 300 psi and a lamination temperature of 220° C. to form the first copper-containing laminate.

### 4. First Copper-Free Laminate (Obtained by Laminating Two First Resin-Coated Coppers)

Each first copper-containing laminate obtained above was etched to remove copper foils on both sides so as to obtain the first copper-free laminate.

### 5. Second Copper-Containing Laminate (Obtained by Laminating One First Resin-Coated Copper)

One first resin-coated copper of each Example and each Comparative Example obtained as described above and one 1 oz hyper very low profile (HVLP) copper foil were prepared, and the first resin-coated copper and the copper foil (adjacent to the semi-cured resin layer of the first resin-coated copper) were stacked, followed by lamination and curing for 2 hours in a high temperature laminator under a vacuum environment with a lamination pressure of 300 psi and a lamination temperature of 220° C. to form the second copper-containing laminate.

### 6. Second Copper-Free Laminate (Obtained by Laminating One First Resin-Coated Copper)

Each second copper-containing laminate obtained above was etched to remove copper foils on both sides so as to obtain the second copper-free laminate.

### 7. Third Copper-Containing Laminate (Obtained by Laminating One First Resin-Coated Copper)

The copper foils on both sides of the second copper-containing laminate were peeled off. The cleaning process was omitted, and the outer copper foil was directly electroplated to an overall copper layer thickness of 35 m to obtain the third copper-containing laminate.

### 8. Fourth Copper-Containing Laminate (Obtained by Laminating One Second Resin-Coated Copper)

One second resin-coated copper of each Example and each Comparative Example obtained as described above and one 1 oz hyper very low profile (HVLP) copper foil were prepared, and the second resin-coated copper and the copper foil (adjacent to the semi-cured resin layer of the second resin-coated copper) were stacked, followed by lamination and curing for 2 hours in a high temperature laminator under a vacuum environment with a lamination pressure of 300 psi and a lamination temperature of 220° C. to form the fourth copper-containing laminate.

### 9. Third Copper-Free Laminate (Obtained by Laminating One Second Resin-Coated Copper)

Each fourth copper-containing laminate obtained above was etched to remove copper foils on both sides so as to obtain the third copper-free laminate.

For each sample, test items and test methods are described below.

### Pressure Cooking Test (PCT) Water Absorption Ratio

In the measurement of PCT water absorption ratio, a 2 inch*2 inch first copper-free laminate (obtained by laminating two first resin-coated coppers) sample was placed in a 105±10° C. oven and baked for 1 hour, then cooled at room temperature of about 25° C. for 10 minutes and weighed to give a weight value W1 representing the weight of the first copper-free laminate; then the sample was subjected to a pressure cooking test (PCT) by reference to IPC-TM-650 2.6.16.1 for 5 hours of moisture absorption (test temperature of 121° C. and relative humidity of 100%) and wiped to remove residual water on the surface; the sample was weighed again to give a weight value W2 representing the weight of the first copper-free laminate after water absorption. The PCT water absorption ratio (%) was calculated as follows: water absorption ratio (%)=[(W2−W1)/W1]*100%.

In the present technical field to which the present disclosure pertains, lower PCT water absorption ratio represents a better property of the sample. A difference in PCT water absorption ratio of greater than or equal to 0.03% represents a substantial difference (i.e., significant technical difficulty) in PCT water absorption ratio of different laminates. For example, articles made from the resin composition disclosed herein have a water absorption ratio in a pressure cooking test as measured by reference to IPC-TM-650 2.6.16.1 of less than or equal to 0.28%, such as between 0.21% and 0.28%.

### Dissipation Factor (Df)

The second copper-free laminate (obtained by laminating one first resin-coated copper) sample was subjected to dissipation factor measurement. Each sample was tested by using a microwave dielectrometer (available from AET Corp.) by reference to JIS C2565 at room temperature (about 25° C.) and under a 10 GHz frequency to obtain the dissipation factor.

In the present technical field to which the present disclosure pertains, lower dissipation factor represents better dielectric properties of the sample, and a difference in dissipation factor of greater than or equal to 0.0004 represents a substantial difference (i.e., significant technical difficulty) in dissipation factor of different laminates. For example, articles made from the resin composition disclosed herein have a dissipation factor as measured by reference to JIS C2565 at 10 GHz of less than or equal to 0.00186, such as between 0.00127 and 0.00186.

Copper Foil Peeling Strength (a.k.a. Peeling Strength, P/S)

In the measurement of copper foil peeling strength, the third copper-containing laminate (obtained by laminating one first resin-coated copper) was cut into a rectangular sample with a width of 24 mm and a length of greater than 60 mm, which was etched to remove surface copper foil to leave a rectangular copper foil with a width of 3.18 mm and a length of greater than 60 mm, and tested by using a tensile strength tester by reference to IPC-TM-650 2.4.8 at room temperature (about 25° C.) to measure the force (lb/in) required to separate the copper foil from the insulation layer of the laminate.

In the present technical field to which the present disclosure pertains, higher copper foil peeling strength is better. A difference in copper foil peeling strength of greater than or equal to 0.3 lb/in represents a substantial difference (i.e., significant technical difficulty) in copper foil peeling strength in different laminates. For example, articles made from the resin composition disclosed herein have a copper foil peeling strength as measured by reference to IPC-TM-650 2.4.8 of greater than or equal to 3.04 lb/in, such as between 3.04 lb/in and 3.24 lb/in.

### X-Axis Coefficient of Thermal Expansion (X-CTE)

The third copper-free laminate (obtained by laminating one second resin-coated copper) sample was tested by thermal mechanical analysis (TMA) during the measurement of X-axis coefficient of thermal expansion. The third copper-free laminate was cut into a sample with a length of 15 mm and a width of 2 mm. Each sample was heated from 50° C. to 260° C. at a temperature increase rate of 5° C./minute and then subjected to the measurement of coefficient of thermal expansion (ppm/° C.) in X-axis in a range (al) from 35° C. to 120° C. by reference to the processes described in IPC-TM-650 2.4.24.5.

In the technical field to which the present disclosure pertains, lower X-axis coefficient of thermal expansion represents a better dimensional expansion property. A difference in X-axis coefficient of thermal expansion of greater than or equal to 2.5 ppm/° C. represents a substantial difference (i.e., significant technical difficulty) in X-axis coefficient of thermal expansion in different laminates. For example, articles made from the resin composition disclosed herein have an X-axis coefficient of thermal expansion as measured by reference to IPC-TM-650 2.4.24.5 of less than or equal to 25.23 ppm/° C., such as between 23.33 ppm/° C. and 25.23 ppm/° C.

### Bending Ability

The second resin-coated copper sample was subjected to a bending ability test. The second resin-coated copper was cut into a sample with a length of 10 cm and a width of 10 cm, which was bent 180° by using a rod with a diameter of 1.5 mm as the axis and a semi-cured resin layer as the inner side, and then the sample was bent 180° with a copper foil layer as the inner side and then restored. The semi-cured resin layer was examined under an optical microscope to determine if there were any cracks (in millimeter, mm) or complete cracking. A designation of “N” is given to represent no crack, a designation of “Y” is given to represent the presence of crack and the size is written, and a designation of “CC” is given to represent complete cracking.

In the present technical field to which the present disclosure pertains, smaller crack in the semi-cured resin layer represents better bending ability. For example, articles made from the resin composition disclosed herein have no cracks in the semi-cured resin layer of the second resin-coated copper during a bending ability test.

The following observations can be made from Table 1 to Table 3.

The resin composition comprising a vinyl group-containing resin, which comprises a vinyl group-containing polyphenylene ether resin, a maleimide resin, a vinyl group-containing polyolefin resin, a vinyl group-containing aromatic fluorene compound or a combination thereof; and a prepolymer prepared from a mixture subjected to a prepolymerization reaction, wherein the mixture comprises a vinyltoluene-divinylbenzene copolymer, a vinyl group-containing aromatic fluorene compound and a benzocyclobutene-modified polybutadiene diacrylate, such as Examples E1 to E13, can all achieve a water absorption ratio in a pressure cooking test (PCT) of less than or equal to 0.28%, a dissipation factor of less than or equal to 0.00186, a copper foil peeling strength of greater than or equal to 3.04 lb/in, an X-axis coefficient of thermal expansion of less than or equal to 25.23 ppm/° C. and no cracks appearing in a semi-cured resin layer after a bending ability test. In contrast, Comparative Examples C1 to C5 fail to achieve desirable results in at least one of the aforesaid properties.

In contrast to Example E1, if a benzocyclobutene-modified polybutadiene diacrylate is not used in the prepolymer, such as Comparative Example C1, it will fail to achieve desirable results in PCT water absorption ratio, dissipation factor, copper foil peeling strength, X-axis coefficient of thermal expansion and bending ability.

In contrast to Example E1, if a vinyl group-containing aromatic fluorene compound is not used in the prepolymer, such as Comparative Example C2, it will fail to achieve desirable results in PCT water absorption ratio, dissipation factor, copper foil peeling strength, X-axis coefficient of thermal expansion and bending ability.

In contrast to Example E1, if a vinyltoluene-divinylbenzene copolymer is not used in the prepolymer, such as Comparative Example C3, it will fail to achieve desirable results in PCT water absorption ratio, dissipation factor, copper foil peeling strength, X-axis coefficient of thermal expansion and bending ability.

In contrast to Example E1, if the prepolymer of the present disclosure is not used but monomers of the prepolymer are separately added instead, such as Comparative Example C4, it will fail to achieve desirable results in PCT water absorption ratio, dissipation factor, copper foil peeling strength, X-axis coefficient of thermal expansion and bending ability.

In contrast to Example E10, if the prepolymer of the present disclosure is not used, such as Comparative Example C5, it will fail to achieve desirable results in PCT water absorption ratio, dissipation factor, copper foil peeling strength, X-axis coefficient of thermal expansion and bending ability.

Overall, the resin composition of the present disclosure and an article made therefrom can all achieve desirable results at the same time including a water absorption ratio in a pressure cooking test (PCT) of less than or equal to 0.28%, a dissipation factor of less than or equal to 0.00186, a copper foil peeling strength of greater than or equal to 3.04 lb/in, an X-axis coefficient of thermal expansion of less than or equal to 25.23 ppm/° C. and no cracks appearing in a semi-cured resin layer after a bending ability test.

The above detailed description and examples are merely illustrative in nature and are not intended to limit the embodiments of the subject matter or the applications and uses of such embodiments. As used herein, the term “exemplary” or similar expression means “serving as an example, instance, or illustration.” Any implementation described herein as exemplary is not necessarily to be construed as preferred or advantageous over other implementations, unless otherwise specified.

Moreover, while at least one exemplary example or comparative example has been presented in the foregoing detailed description, it should be appreciated that a vast number of variations exist. It should also be appreciated that the exemplary one or more embodiments described herein are not intended to limit the scope, applicability, or configuration of the claimed subject matter in any way. Rather, the foregoing detailed description can provide those skilled in the art with a convenient guide for implementing the described one or more embodiments and equivalents thereof. Also, the scope defined by the claims includes known equivalents and foreseeable equivalents at the time of filing this patent application.

What is claimed is:

1. A resin composition, comprising:
a vinyl group-containing resin, which comprises a vinyl group-containing polyphenylene ether resin, a maleimide resin, a vinyl group-containing polyolefin resin, a vinyl group-containing aromatic fluorene compound or a combination thereof; and
a prepolymer prepared from a mixture subjected to a prepolymerization reaction, the mixture comprising a vinyltoluene-divinylbenzene copolymer, a vinyl group-containing aromatic fluorene compound and a benzocyclobutene-modified polybutadiene diacrylate.

2. The resin composition of claim 1, comprising 100 parts by weight of the vinyl group-containing resin and 10 parts by weight to 60 parts by weight of the prepolymer.

3. The resin composition of claim 1, wherein the mixture comprises 100 parts by weight of the vinyltoluene-divinylbenzene copolymer, 5 parts by weight to 20 parts by weight of the vinyl group-containing aromatic fluorene compound and 15 parts by weight to 30 parts by weight of the benzocyclobutene-modified polybutadiene diacrylate.

4. The resin composition of claim 1, wherein the vinyl group-containing polyphenylene ether resin comprises a vinylbenzyl group-containing biphenyl polyphenylene ether resin, a methacrylate group-containing polyphenylene ether resin or a combination thereof.

5. The resin composition of claim 1, wherein the maleimide resin comprises 4,4′-diphenylmethane bismaleimide, polyphenylmethane maleimide, bisphenol A diphenyl ether bismaleimide, 3,3′-dimethyl-5,5′-diethyl-4,4′-diphenylmethane bismaleimide, 3,3″-dimethyl-5,5′-dipropyl-4,4′-diphenylmethane bismaleimide, m-phenylene bismaleimide, 4-methyl-1,3-phenylene bismaleimide, 1,6-bismaleimide-(2,2,4-trimethyl)hexane, N-2,3-dimethylphenyl maleimide, N-2,6-dimethylphenyl maleimide, N-phenylmaleimide, vinyl benzyl maleimide, maleimide containing biphenyl structure, maleimide containing indane structure, maleimide containing C₁₀ to C₅₀ aliphatic long chain structure or a combination thereof.

6. The resin composition of claim 1, wherein the vinyl group-containing polyolefin resin comprises polybutadiene, polyisoprene, butadiene-styrene copolymer, polydicyclopentadiene, styrene-isoprene copolymer, styrene-butadiene-divinylbenzene terpolymer, styrene-butadiene-maleic anhydride terpolymer, vinyl-polybutadiene-urethane oligomer, maleic anhydride-butadiene copolymer, polymethylstyrene, styrene-maleic anhydride copolymer, maleic anhydride-modified polybutadiene-styrene copolymer or a combination thereof.

7. The resin composition of claim 1, wherein the vinyl group-containing aromatic fluorene compound comprises a compound of Formula (1):

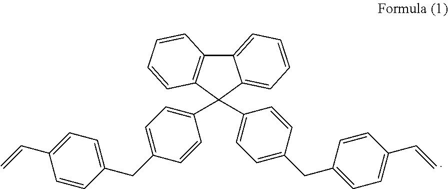 [SMILES: C=Cc1ccc(Cc2ccc(C3(c4ccc(Cc5ccc(C=C)cc5)cc4)c4ccccc4-c4ccccc43)cc2)cc1]

8. The resin composition of claim 1 further comprising a vinyl group-substituted 9,10-dihydro-9-oxa-0-phosphaphenanthrene-10-oxide.

9. The resin composition of claim 1, further comprising inorganic filler, flame retardant, curing accelerator, polymerization inhibitor, solvent, silane coupling agent, coloring agent, toughening agent or a combination thereof.

10. An article made from the resin composition of claim 1, comprising a resin-coated copper, a laminate or a printed circuit board.

11. The article of claim 10, which has one, more or all of the following properties:
a water absorption ratio in a pressure cooking test as measured by reference to IPC-TM-650 2.6.16.1 of less than or equal to 0.28%;
a dissipation factor as measured by reference to JIS C22565 at 10 GHz of less than or equal to 0.00186;
a copper foil peeling strength as measured by reference to IPC-TM-650 2.4.8 of greater than or equal to 3.04 lb/in;
an X-axis coefficient of thermal expansion as measured by reference to IPC-TM-650 2.4.24.5 of less than or equal to 25.23 ppm/° C.; and
no cracks appearing in a semi-cured resin layer after a bending ability test.
